(19) United States
(12) Patent Application Publication
(10) Pub. No.: US 2014/0282233 A1
(43) Pub. Date: Sep. 18, 2014

(54) GRAPHICAL ELEMENT EXPANSION AND CONTRACTION

(71) Applicant: Google Inc., Mountain View, CA (US)

(72) Inventors: Daniel Robert Sandler, Burlington, MA (US); Michael Andrew Cleron, Menlo Park, CA (US); Gabriel Aaron Cohen, Alameda, CA (US); Daniel Marc Gatan Shiplacoff, Los Altos, CA (US); Christopher Richard Wren, Arlington, MA (US); Lee Brandon Keely, San Francisco, CA (US)

(21) Appl. No.: 13/835,728

(22) Filed: Mar. 15, 2013

(51) Int. Cl. G06F 3/0484

(52) U.S. Cl. CPC G06F 3/0484
USPC 715/800

(57) ABSTRACT

A computing device (CD) outputs a graphical user interface (GUI) for display at a display device (DD). The GUI includes a grouping of elements that includes an expandable element (EE) having a first size. While the DD displays a first or a last element of the grouping, the CD receives an indication of a gesture including a linear movement of an input point away from the first or last element, e.g., in a direction in which the EE is expandable, and outputs a modified GUI that includes the EE having a second size. Alternatively, the GUI includes multiple EEs having respective sizes. The CD receives an indication of a gesture including a linear movement of multiple input points across the DD, and, while the input points are located within a region of the DD that displays an EE, outputs a modified GUI that includes the EE having a different size.

### BACKGROUND

Computing devices in general, and mobile computing devices in particular, may enable user interaction through touch-based or, more generally, presence-based input. For example, some mobile computing devices may include or be coupled to (e.g., operatively or wirelessly coupled to) devices that detect presence input, such as touchscreen-enabled, or, more generally, presence-sensitive displays. In some examples, a mobile computing device may receive, or generate, and subsequently display one or more user notifications to a user of the mobile computing device. The user notifications may be directed to the user from another user, from an application executable by the mobile computing device, or from the computing device itself. In some examples, to display the user notifications, the mobile computing device may output a graphical user interface (GUI) for display at a display device (e.g., a presence-sensitive display and/or another display operatively coupled to the mobile computing device). The GUI may include one or more graphical elements that are representative of the user notifications. In some instances, one or more of the graphical elements used to represent the user notifications may be relatively small (e.g., have a relatively narrow dimension compared to another, relatively wide dimension). In such instances, it may be difficult for the user of the mobile computing device to interact with, or manipulate, a particular graphical element by placing one or more fingers, styli, or other input unit(s) within a region of a device that detects presence input (e.g., apresence-sensitive display that also displays the particular graphical element).

### SUMMARY

In one example, a method includes outputting, by a computing device and for display at a display device, a graphical user interface (GUI) that includes a substantially linear grouping of elements, the grouping including an expandable element having a first size. The method further includes, while the display device displays at least one of a first element and a last element of the grouping, receiving, by the computing device, an indication of a gesture detected at a presence-sensitive input device, the gesture including a substantially linear movement of an input point substantially away from one of the at least one of the first and last elements. The method also includes, responsive to receiving the indication of the gesture, outputting, by the computing device and for display at the display device, a modified GUI that includes the expandable element having a second size different from the first size.

In another example, a method includes outputting, by a computing device and for display at a display device, a GUI that includes a first expandable element having a first size and a second expandable element having a second size. The method further includes receiving, by the computing device, an indication of a multi-touch gesture detected at a presence-sensitive input device, the multi-touch gesture including a substantially linear movement of a plurality of input points detected as being present concurrently at the presence-sensitive input device from a first region of the presence-sensitive input device toward a second region of the presence-sensitive input device. The method still further includes, while the plurality of input points is located substantially within a third region of the presence-sensitive input device that corresponds to a region of the display device that displays the first expandable element, outputting, by the computing device for display at the display device and in response to receiving the indication of the multi-touch gesture, a modified GUI that includes the first expandable element having a third size different from the first size. The method also includes, while the plurality of input points at the presence-sensitive display is located substantially within a fourth region of the presence-sensitive display that displays the second expandable element, outputting, by the computing device for display at the presence-sensitive display and in response to receiving the indication of the multi-touch gesture, another modified GUI that includes the second expandable element having a fourth size different from the second size.

In another example, a computing device includes one or more processors configured to output, for display at a display device, a GUI that includes a substantially linear grouping of elements, the grouping including an expandable element having a first size. The one or more processors may be further configured to, while the display device displays at least one of a first element and a last element of the grouping, receive an indication of a gesture detected at a presence-sensitive input device, the gesture including a substantially linear movement of an input point substantially away from one of the at least one of the first and last elements in a direction that is substantially parallel to a direction in which the expandable element expands. The one or more processors may also be configured to, responsive to receiving the indication of the gesture, output, for display at the presence-sensitive display, a modified GUI that includes the expandable element having a second size different from the first size.

In another example, a computing device includes one or more processors configured to output, for display at a display device, a GUI that includes a first expandable element having a first size and a second expandable element having a second size. The one or more processors may be further configured to receive an indication of a multi-touch gesture detected at the presence-sensitive display, the multi-touch gesture including a substantially linear movement of a plurality of input points detected concurrently at the presence-sensitive display from a first region of the presence-sensitive display toward a second region of the presence-sensitive display. The one or more processors may also be configured to, while the plurality of input points at the presence-sensitive display is located substantially within a third region of the presence-sensitive display that displays the first expandable element, output, for display at the presence-sensitive display and in response to receiving the indication of the multi-touch gesture, a modified GUI that includes the first expandable element having a third size different from the first size. Additionally, the one or more processors may be configured to, while the plurality of input points at the presence-sensitive display is located substantially within a fourth region of the presence-sensitive display that displays the second expandable element, output, for display at the presence-sensitive display and in response to receiving the indication of the multi-touch gesture, another modified GUI that includes the second expandable element having a fourth size different from the second size.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram that illustrates an example computing device that outputs a graphical user interface (GUI) for display at a presence-sensitive display, in accordance with one or more aspects of this disclosure.

FIG. 2 is a block diagram that illustrates an example configuration of the computing device of FIG. 1, in accordance with one or more aspects of this disclosure.

FIG. 3 is a block diagram that illustrates an example in which the computing device of FIG. 1 outputs graphical content for display at one or more remote display devices, in accordance with one or more aspects of this disclosure.

FIGS. 4A-4C are conceptual diagrams that illustrate example GUIs provided by the computing device of FIG. 1, in accordance with one or more aspects of this disclosure.

FIGS. 5A-5C are conceptual diagrams that illustrate additional example GUIs provided by the computing device of FIG. 1, in accordance with one or more aspects of this disclosure.

FIG. 6 is a flowchart that illustrates an example process for visually expanding or collapsing one or more graphical elements using a single gesture, in accordance with one or more aspect of this disclosure.

FIG. 7 is a flowchart that illustrates another example process for visually expanding or collapsing one or more graphical elements using a single gesture, in accordance with one or more aspects of this disclosure.

### DETAILED DESCRIPTION

In general, techniques of this disclosure are directed to expanding and collapsing graphical elements, such as, for example, user notifications, in response to receiving user input. For example, a computing device may be configured to provide a graphical user interface (GUI) for display to a user of the computing device at a display device, such as a presence-sensitive display. The GUI may include a variety of objects and information, including one or more expandable elements, each of which may be expanded or collapsed to include more or less information, respectively. In some examples, the elements may include user notifications, such as notifications to the user from another user, from an application executable by the computing device, or from the computing device itself. Typically, the computing devices are configured to require the user to perform one particular gesture at the display device for each element the user would like to expand or collapse. As such, in order to expand or collapse, for example, five elements, a computing device may require the user to perform five separate gestures. Additionally, to perform a particular gesture, the computing device may be configured to require the user to place one or more fingers or styli within a region of the display device used by the computing device to display the element. In some instances, however, the element may be relatively small, making it difficult for a user to place one or more fingers or styli within a region of the display device that displays the element.

According to the techniques disclosed herein, a computing device may be configured to enable the user to perform a single gesture to expand or collapse one or more expandable elements of the GUI, such that, e.g., the user may successively expand or collapse multiple expandable elements of the GUI using the single gesture. In one example, the computing device may be configured to require the user to place a finger or another input unit at or proximate to the display device, and perform a so-called “scroll,” “drag,” or “pull” gesture. For example, the computing device may be configured to require the user to move the finger or input unit across, or proximate to, a region of the display device that displays a grouping, or “list,” of the elements of the GUI. In response to the gesture, the computing device may navigate through the grouping, and eventually display a beginning or an ending of the grouping at the display device. If the user continues to perform the gesture after the computing device has displayed the beginning or the ending of the grouping, the computing device may be configured to expand or collapse one or more elements of the GUI. For example, the computing device may be configured to expand or collapse the one or more elements in a “top-to-bottom” or “bottom-to-top” sequential manner, based on the continued user gesture.

In some instances, the computing device may display a beginning or an ending of a list of expandable elements of the GUI. For example, the computing device may be configured to display the beginning or ending of the list in response to a first gesture, such as a “scroll,” “drag,” or “pull” gesture, performed by the user. In this example, one or more of the expandable elements may be in a collapsed state, or simply “collapsed.” Also in this example, while the computing device displays the beginning or ending of the list and while the user performs another, second scroll, drag, or pull gesture in a direction that is away from the beginning or ending of the list, the computing device may be configured to expand the one or more collapsed expandable elements. For example, the second gesture may be the same as, or similar to, the first gesture, or be a continuation of the first gesture. In this example, the computing device may be configured to expand the collapsed expandable elements one at a time, e.g., starting from a first, top-most element, and proceeding to a last, bottom-most element of the collapsed expandable elements within the list, or vice versa. In this manner, until the user stops performing the second gesture, or until all of the collapsed expandable elements of the GUI have been expanded, the computing device may be configured to expand the collapsed expandable elements sequentially, i.e., one after another.

In another example, the computing device may be configured to require the user to place multiple fingers or other input units at, or proximate to, the display device and perform a so-called “swipe” or “tug” gesture. For example, the computing device may be configured to require the user to move the multiple fingers or input units across, or proximate to, a region of the display device that displays two or more of the elements of the GUI. In response to the gesture, and while the fingers or input units are located within a first region of the display device that displays a particular first element of the GUI, the computing device may be configured to expand or collapse the element. If the user continues to perform the gesture, after the computing device has expanded or collapsed the first element, the fingers or input units eventually will be located outside of the region of the display device that displays the first element. While the user continues to perform the same gesture, and while the fingers or input units are located within a second region of the display device that displays a subsequent second element of the GUI, the computing device may be configured to expand or collapse the second element. In this example, the fingers or input units being located within each of the first and second regions of the display device that displays the corresponding one of the first and second elements of the GUI may correspond to the fingers or input units being located on a boundary of the respective region. In this manner, the computing device may be configured to expand or collapse multiple elements of the GUI in a sequential manner, based on the same continued user gesture.

In some instances, the computing device may be configured to expand a particular first collapsed expandable element of the GUI in response to the user performing a first “pull-down” gesture (e.g., a downward two-finger swipe gesture) to expand the element. After the computing device expands the first element in response to the first gesture, and while the user continues to perform the first gesture and moves beyond a boundary of the first element, the computing device may be configured to expand a subsequent collapsed expandable element of the GUI. In other instances, the computing device may be configured to collapse a particular second expanded expandable element of the GUI in response to the user performing a second “pull-up” gesture (e.g., an upward two-finger swipe gesture) to collapse the element, in a similar manner as described above. In the above-described examples, each of the first and second expandable elements expanded or collapsed by computing device may be identified by a location where the corresponding one of the first and second gestures was initiated. In these examples, when (e.g., in response to determining that) each of the first and second gestures performed by the user moves beyond (i.e., outside of) a boundary of the respective one of the first and second elements, the computing device may be configured to expand or collapse a subsequent collapsed or expanded expandable element of the GUI. The above-described processes may be repeated relative to other expandable elements of the GUI until the user stops performing the respective gesture, or until all expandable elements of the GUI have been expanded or collapsed.

In this manner, techniques of this disclosure may enable a computing device to be configured such that a user of the computing device may perform a single gesture to expand or collapse one or more graphical elements of a GUI output by the computing device for display at a presence-sensitive display. In particular, the disclosed techniques may enable the user to more easily expand or collapse the one or more elements. As one example, the techniques may enable the user to successively expand or collapse multiple graphical elements of the GUI using the single gesture. As another example, the techniques may enable the user to expand or collapse a particular graphical element of the GUI using the single gesture in instances where using another expansion or collapsing gesture that requires placement of one or more fingers or styli within a region of the presence-sensitive display that displays the element difficult or impractical.

FIG. 1 is a conceptual diagram that illustrates an example computing device 100 that outputs GUI 102 for display at presence-sensitive display 140, in accordance with one or more aspects of this disclosure. In the example of FIG. 1, computing device 100 may include, be, or be a part of, one or more of a variety of types of computing devices, such as mobile phones (including smartphones), tablet computers, netbooks, laptops, personal digital assistants (“PDAs”), watches, and/or other types of devices. In other examples, computing device 100 may be one or more processors, e.g., one or more processors of one or more of the computing devices described above. As shown in FIG. 1, computing device 100 includes user interface device 138, which, in turn, includes, or is communicatively coupled to, presence-sensitive display 140, as well as user interface module 152 and gesture module 154.

Computing device 100 may output GUI 102 for display using a variety of display devices, such as a presence-sensitive display (e.g., presence-sensitive display 140), or another type of input/output (I/O) capable display device (e.g., a touchscreen-enabled display device). For ease of explanation, this disclosure describes computing device 100 as including, or being communicatively coupled to, presence-sensitive display 140. GUI 102 includes expandable elements 106-116. Each of elements 106-116 includes one of a variety of user notifications, as depicted in the respective element in FIG. 1. In other examples, GUI 102 may include additional expandable elements that do not contain user notifications. For instance, in some examples, GUI 102 may include expandable graphics (e.g., icons, images, or photos) or text, as well as other types of expandable elements. Moreover, in still other examples, GUI 102 also may include other objects and information, in addition to elements 106-116 shown in FIG. 1, such as icons, status bars, battery gauges, wireless signal strength gauges, and so forth.

In the example of FIG. 1, each of elements 106-116 is shown in a collapsed state. In this example, each of elements 106-116 is expandable and collapsible in a direction indicated by the corresponding one of arrows 118-128 (i.e., in an upward/downward direction). In other examples, however, expandable elements of GUI 102 may be expandable or collapsible in other directions (e.g., in a left/right direction, or in a diagonal direction), as explained in greater detail below.

In some examples, computing device 100 may receive an indication of a user input, such as a gesture, detected at presence-sensitive display 140. In accordance with the techniques of this disclosure, as one example, the gesture may include a substantially linear movement of one or more input points. In other words, in this example, the gesture may be a single-touch gesture, or a multi-touch gesture. Also in this example, the substantially linear movement of the one or more input points may be substantially away from a particular item of GUI 102. For example, the particular item may be an element of GUI 102, such as any of the “first” and “last” elements 106 and 116, respectively, of the grouping of elements 106-116 of GUI 102, or a portion of an element of GUI 102. In some examples, the element, or the portion thereof, may be positioned at a particular boundary of a region of presence-sensitive display 140 (e.g., region 104 of presence-sensitive display 140 used to display the grouping of elements 106-116). As another example, the gesture may be a multi-touch gesture that includes a substantially linear movement of a plurality of input points detected concurrently at presence-sensitive display 140. In this example, the substantially linear movement of the plurality of input points may be from a first region of presence-sensitive display 140 toward a second region of presence-sensitive display 140.

In any case, computing device 100 may detect and interpret each gesture, and expand or collapse one or more expandable elements (e.g., one or more of elements 106-116) of GUI 102 in response to detecting and interpreting the gesture. For example, computing device 100 may expand or collapse a single expandable element of GUI 102, or expand or collapse multiple expandable elements of GUI 102 in a successive manner, in response to detecting and interpreting each gesture.

In one particular example of the techniques of this disclosure, computing device 100 may be configured to output, for display at presence-sensitive display 140, GUI 102 (e.g., as depicted in FIG. 4A, which is described in greater detail below) that includes a substantially linear grouping of elements 106-116. In this example, the grouping may include an expandable element (e.g., element 106) having a first size. For example, computing device 100 may be configured to output GUI 102 via user interface device 138 that includes, or is communicatively coupled to, presence-sensitive display 140, as shown in FIG. 1.

Also in this example, computing device 100 may receive an indication of a gesture detected at presence-sensitive display 140 while presence-sensitive display 140 displays at least one of first element 106 and last element 116 of the grouping, e.g., according to an ordering of elements 106-116 within the grouping. For example, presence-sensitive display 140 may display the at least one of first and last elements 106, 116, such that at least one of first and second elements 106, 116 is aligned with a boundary of region 104. As shown in FIG. 1, first element 106 is aligned with an upper boundary of region 104, while last element 116 is located elsewhere within region 104. In other examples, however, first element 106 may be aligned with the upper boundary of region 104, while last element 116 may be aligned with a lower boundary of region 104.

Moreover, presence-sensitive display 140 may display each of the at least one of first and last elements 106, 116 in its entirety. In other words, presence-sensitive display 140 may display one or both of a beginning and an ending of the grouping of elements 106-116, as defined by first and last elements 106, 116, respectively, rather than, e.g., some other portion of the grouping where both of first and last elements 106, 116 are not displayed on presence-sensitive display 140 in their entirety (i.e., are partially or wholly “hidden” from view).

In this manner, computing device 100 may receive the indication of the above-described gesture while presence-sensitive display 140 displays the beginning and/or the ending of the grouping, e.g., in response to a previous user “scroll” gesture that navigates through the grouping until presence-sensitive display 140 displays the beginning and/or ending of the grouping.

In the particular example described above, the gesture may include a substantially linear movement of one or more input points substantially away from one of the at least one of first and last elements 106, 116 in a direction that is substantially parallel to a direction in which the expandable element expands (e.g., a direction indicated by a corresponding one of arrows 118-128). For example, computing device 100 may receive the indication of the gesture detected at presence-sensitive display 140 using one or more of user interface device 138, user interface module 152, and gesture module 154.

Also in this example, computing device 100 may be configured to, responsive to receiving the indication of the gesture and for display at presence-sensitive display 140, output a modified GUI 102 (e.g., GUI 102 as depicted in FIG. 4B, which is also described in greater detail below) that includes the expandable element having a second size different from the first size. For example, computing device 100 may output the “modified” version of GUI 102 that includes the expandable element having the second size in place of the “original” version of GUI 102 that includes the expandable element having the first size by expanding or collapsing the expandable element having the first size, as will be described in greater detail below with reference to FIGS. 4A-4C.

As previously explained, computing device 100 may output the modified version of GUI 102 in response to receiving the indication of the above-described gesture while presence-sensitive display 140 displays the beginning and/or the ending of the grouping. In other examples, computing device 100 may make no modifications to GUI 102, or respond in some other manner, responsive to receiving an indication of a similar gesture while presence-sensitive display 140 displays some other portion of the grouping that does not include one or both of the beginning or the ending of the grouping.

Additionally, in some examples, the gesture may be initiated within a region of presence-sensitive display 140 that displays the expandable element. In these examples, the gesture may further include a substantially linear movement of the one or more input points substantially toward the one of the at least one of first element 106 and last element 116 and substantially parallel to the direction in which the expandable element expands. For example, the additional substantially linear movement of the one or more input points of the gesture may be performed in conjunction with the above-described substantially linear movement of the one or more input points substantially away from the one of the at least one of first and last elements 106, 116.

In some examples, in instances where the gesture corresponds to a collapsing gesture, the gesture may include both of the above-described substantially linear movements of the one or more input points being performed in a particular order. For example, initially, the substantially linear movement of the one or more input points substantially away from the one of the at least one of first and last elements 106, 116 (e.g., element 106) may initiate the collapsing gesture. This “component” of the collapsing gesture being initiated within the region of presence-sensitive display 140 that displays the expandable element may identify the expandable element as an expandable element that is to be collapsed. Subsequently, the substantially linear movement of the one or more input points substantially toward the one of the at least one of first and last elements 106, 116 may constitute the collapsing gesture itself, i.e., cause computing device 100 to collapse the expandable element in response to the collapsing gesture.

In these examples, in response to receiving an indication of the substantially linear movement of the one or more input points substantially away from the one of the at least one of first and last elements 106, 116, computing device 100 may output for display at presence-sensitive display 140 a modified version of GUI 102 that includes an indication that the collapsing gesture has been initiated with respect to the expandable element. For example, the indication may include visual (e.g., using “highlighting,” or other means of visually manipulating the expandable element), audible (e.g., playback of a particular sound), or haptic (e.g., actuation of a vibrating motor) feedback. Additionally, in response to receiving an indication of the substantially linear movement of the one or more input points substantially toward the one of the at least one of first and last elements 106, 116, computing device 100 may output for display at presence-sensitive display 140 another modified version of GUI 102 that includes the expandable element collapsed.

Also in these examples, computing device 100 may output the further modified version of GUI 102 that includes the expandable element collapsed when (e.g., in response to determining that) the one or more input points are located outside of the region of presence-sensitive display 140 that displays the expandable element. For example, while the gesture may be initiated within the region of presence-sensitive display 140 that displays the expandable element, as described above, computing device 100 may output the further modified GUI 102 in response to receiving the indication of the collapsing gesture after the one or more input points are no longer located within the region.

Furthermore, in some examples, the gesture may include a substantially linear movement of multiple input points (e.g., a first input point and a second input point) substantially away from the one of the at least one of first and last elements 106, 116 in the direction that is substantially parallel to the direction in which the expandable element expands. In this manner, the above-described techniques may be performed using a single-touch gesture (e.g., using a single finger or stylus), as well as a multi-touch gesture (e.g., using a plurality of fingers and/or styli), to expand or collapse one or more expandable elements.

As another particular example of the techniques of this disclosure, computing device 100 may be configured to output, for display at presence-sensitive display 140, GUI 102 (e.g., GUI 102 as depicted in FIG. 5A, which is described in greater detail below) that includes a first expandable element (e.g., element 106) having a first size and a second expandable element (e.g., element 108) having a second size. Computing device 100 may be further configured to receive an indication of a multi-touch gesture detected at presence-sensitive display 140. In this example, the multi-touch gesture may include a substantially linear movement of a plurality of input points detected concurrently at presence-sensitive display 140 from a first region of presence-sensitive display 140 toward a second region of presence-sensitive display 140.

Computing device 100 may, while the plurality of input points at presence-sensitive display 140 is located substantially within a third region of presence-sensitive display 140 that displays the first expandable element, output, for display at presence-sensitive display 140 and in response to receiving the indication of the multi-touch gesture, a modified GUI 102 (e.g., GUI 102 as depicted in FIG. 5B, which is also described in greater detail below) that includes the first expandable element having a third size different from the first size. Computing device 100 also may, while the plurality of input points at presence-sensitive display 140 is located substantially within a fourth region of presence-sensitive display 140 that displays the second expandable element, output, for display at presence-sensitive display 140 and in response to receiving the indication of the multi-touch gesture, another modified GUI 102 (e.g., GUI 102 as depicted in FIG. 5C, which is also described in greater detail below), that includes the second expandable element having a fourth size different from the second size.

For example, the plurality of input points at presence-sensitive display 140 being located substantially within each of the third and fourth regions of presence-sensitive display 140 that displays the corresponding one of the first and second expandable elements may correspond to the plurality of input points being located substantially on a boundary of the respective region. Furthermore, computing device 100 may output the “modified” and “further modified” versions of GUI 102 that include the first and second expandable elements having the third and fourth sizes, respectively, in place of the “original” version of GUI 102 that includes the first and second expandable elements having the first and second sizes, respectively, by expanding or collapsing the first and second expandable elements having the first and second sizes, as will be described in greater detail below with reference to FIGS. 5A-5C.

FIG. 2 is a block diagram that illustrates an example configuration of computing device 100 of FIG. 1, in accordance with one or more aspects of this disclosure. FIG. 2 illustrates only one particular example of computing device 100, and many other examples of computing device 100 may be used in other instances, and may include a subset of the components included in example computing device 100, or may include additional components not shown in FIG. 2. Although FIG. 2 and the subsequent figures are described with reference to computing device 100 of FIG. 1, the techniques of this disclosure are not limited to the example of FIG. 1.

As shown in FIG. 2, computing device 100 includes one or more processors 130, one or more input devices 132, one or more output devices 134, one or more communication devices 136, user interface device 138, and one or more storage devices 144. In the example of FIG. 2, user interface device 138 includes presence-sensitive display 140. Also in this example, storage devices 144 include operating system 146, user interface module 152, gesture module 154, communication module 156, application modules 158A-158N, and system settings 160. As shown in FIG. 2, operating system 146 includes notification service module 148 and system settings module 150. As also shown in FIG. 2, the various components of computing device 100 are interconnected via one or more communication channels 142 (e.g., one or more signals, or signal “busses,” or communication interfaces).

Processors 130 may be configured to implement functionality and/or process instructions for execution within computing device 100. For example, processors 130 may process instructions stored in storage devices 144 (e.g., within a subset of storage devices 144 allocated for storing the instructions, such as one or more volatile and/or non-volatile memory devices). Such instructions may include components of operating system 146 (i.e., notification service module 148, system settings module 150, and other components), as well as user interface module 152, gesture module 154, communication module 156, application modules 158A-158N, and system settings 160, also included within storage devices 144.

Input devices 132 may receive input from a user through tactile, audio, video, or biometric channels. Examples of input devices 132 may include a keyboard, mouse, touchscreen, presence-sensitive display, microphone, one or more still and/or video cameras, fingerprint reader, retina scanner, or any other device capable of detecting an input from a user or other source, and relaying the input to computing device 100 or components thereof. Output devices 134 of computing device 100 may be configured to provide output to a user through visual, auditory, or tactile channels. Output devices 134 may include a video graphics adapter card, a liquid crystal display (LCD) monitor, a light emitting diode (LED) monitor, a cathode ray tube (CRT) monitor, a sound card, a speaker, or any other device capable of generating output that may be intelligible to a user. Input devices 132 and/or output devices 134 also may include a discrete touchscreen and a display, or a touchscreen-enabled display, a presence-sensitive display, or other I/O capable displays known in the art. In this disclosure, although input devices 132 and/or output devices 134 are described as being separate from user interface device 138 described in greater detail below, one or more of input devices 132 and output devices 134, or any components thereof, may be integrated within user interface device 138 and various components thereof (e.g., within presence-sensitive display 140), in any manner.

User interface device 138, which includes presence-sensitive display 140, may be configured to, in conjunction with user interface module 152 and/or gesture module 154, implement the functionality of computing device 100 that relates to outputting, for display at presence-sensitive display 140 a GUI (e.g., GUI 102 of FIG. 1) that includes one or more expandable elements having particular sizes, receiving an indication of a gesture detected at presence-sensitive display 140 (e.g., with the assistance of gesture module 154), and outputting, for display at presence-sensitive display 140 and in response to receiving the indication of the gesture, a modified GUI that includes the one or more expandable elements having different sizes. For example, user interface device 138 may comprise any suitable arrangement of hardware, software, firmware, or any combination thereof, to perform the techniques attributed to user interface device 138 in this disclosure.

In general, user interface device 138 may include any of one or more microprocessors, microcontrollers, digital signal processors (DSPs), application specific integrated circuits (ASICs), field programmable gate arrays (FPGAs), or any other equivalent integrated or discrete logic circuitry, as well as any combination of such components. Furthermore, user interface device 138 may include various types of analog circuitry, in addition to, or in place of, the logic devices and circuitry described above, as well as any number of mechanical, electro-mechanical, and structural hardware and components. Also, as described above with reference to FIG. 1, presence-sensitive display 140 may include any of a discrete LCD monitor, LED monitor, and CRT monitor, along with a discrete touchscreen (e.g., a resistive or capacitive touchscreen), or a touchscreen-enabled display, a presence-sensitive display, or any other I/O capable display known in the art.

In some examples, computing device 100 may use communication devices 136, in conjunction with communication module 156, to communicate with other devices via one or more networks, such as one or more wired or wireless networks. Communication devices 136, which may be referred to as a network interface, may include a network interface card, such as an Ethernet card, an optical transceiver, a radio frequency transceiver, or any other type of device that can send and receive information. Other examples of communication devices 136 may include Bluetooth®, 3G, 4G, and WiFi® radios in mobile computing devices, as well as a universal serial bus (USB) port. In some examples, computing device 100 may use communication devices 136 to wirelessly communicate with other, e.g., external, devices over a wireless network.

Storage devices 144 may include one or more computer-readable storage media. For example, storage devices 144 may be configured for long-term, as well as short-term storage of information, such as, e.g., instructions, data, or other information used by computing device 100. In some examples, storage devices 144 may include non-volatile storage elements. Examples of such non-volatile storage elements include magnetic hard discs, optical discs, solid state discs, floppy discs, flash memories, forms of electrically programmable memories (e.g., EPROMs), or electrically erasable and programmable memories (e.g., EEPROMs), as well as other forms of non-volatile memories known in the art. In other examples, in place of, or in addition to the non-volatile storage elements, storage devices 144 may include one or more so-called “temporary” memory devices, meaning that a primary purpose of these devices may not be long-term data storage. For example, the devices may comprise volatile memory devices, meaning that the devices may not maintain stored contents when the devices are not receiving power. Examples of volatile memory devices include random access memories (RAM), dynamic random access memories (DRAM), static random access memories (SRAM), and other forms of volatile memories, or memory devices, known in the art. In some examples, the devices may store program instructions for execution by processors 130. For example, the devices may be used by software (e.g., operating system 146) or applications (e.g., one or more of application modules 158A-158N) executing on computing device 100 to temporarily store information during program execution.

Operating system 146 may control one or more functionalities of computing device 100 and/or components thereof. For example, operating system 146 may interact with any of user interface module 152, gesture module 154, communication module 156, and application modules 158A-158N, and may facilitate one or more interactions between the respective modules and processors 130, input devices 132, output devices 134, communication devices 136, and user interface device 138 (including presence-sensitive display 140). Although not shown in FIG. 2, operating system 146 may interact with, or be otherwise coupled to, any of the modules described above, as well as to any components thereof. In some examples, one or more of the modules described above may be included within (or be otherwise provided by) operating system 146. Additionally, notification service module 148, shown as included within operating system 146, may be used by operating system 146 to control one or more functionalities of computing device 100 described herein, relating to providing user notifications to a user (e.g., by receiving user notifications via communication devices 136). Furthermore, system settings module 150, in conjunction with system settings 160, may be used by operating system 146 to initialize and/or update various system settings of computing device 100. Additionally, in some instances, computing device 100 also may use communication devices 136 to access and implement the functionalities provided by computing device 100 and its components, as described above, through methods commonly known as “cloud computing.”

In general, computing device 100 may include any combination of one or more processors, one or more FPGAs, one or more ASICs, and one or more application specific standard products (ASSPs). Computing device 100 also may include memory, both static (e.g., hard drives or magnetic drives, optical drives, FLASH memory, EPROM, EEPROM, etc.) and dynamic (e.g., RAM, DRAM, SRAM, etc.), or any other non-transitory computer readable storage medium capable of storing instructions that cause the one or more processors, FPGAs, ASICs, or ASSPs, to perform the GUI graphical element expansion and collapsing techniques described herein. Thus, computing device 100 may represent hardware, or a combination of hardware and software, to support the described components, modules, or elements, and the techniques should not be strictly limited to any particular embodiment described herein. Computing device 100 also may include one or more additional components not shown in FIG. 2, such as a global positioning system (GPS) receiver, and a radio frequency identification (RFID) reader, among other components, as well as one or more additional processors, input devices, output devices, communication devices (e.g., so-called “network interfaces”), user interface devices, storage devices, power sources, and so forth.

As one example, user interface device 138, in conjunction with user interface module 152, may be configured to output, for display at presence-sensitive display 140, a GUI (e.g., GUI 102 of FIG. 1) that includes a substantially linear grouping of elements, the grouping including an expandable element having a first size. User interface device 138 may be further configured to, while presence-sensitive display 140 displays at least one of a first element and a last element of the grouping, e.g., according to an ordering of the elements within the grouping, receive an indication of a gesture detected at presence-sensitive display 140, e.g., with the assistance of gesture module 154. In this example, the gesture may include a substantially linear movement of an input point substantially away from one of the at least one of the first and last elements in a direction that is substantially parallel to a direction in which the expandable element expands. User interface device 138 may be still further configured to, responsive to receiving the indication of the gesture, output, for display at presence-sensitive display 140, a modified GUI that includes the expandable element having a second size different from the first size.

As another example, user interface device 138, in conjunction with user interface module 152, may be configured to output, for display at presence-sensitive display 140, a GUI (e.g., GUI 102 of FIG. 1) that includes a first expandable element having a first size and a second expandable element having a second size. User interface device 138 may be further configured to receive an indication of a multi-touch gesture detected at presence-sensitive display 140, e.g., with the assistance of gesture module 154. In this example, the multi-touch gesture may include a substantially linear movement of a plurality of input points detected concurrently at presence-sensitive display 140 from a first region of presence-sensitive display 140 toward a second region of presence-sensitive display 140. User interface device 138 may be still further configured to, while the plurality of input points at presence-sensitive display 140 is located substantially within a third region of presence-sensitive display 140 that displays the first expandable element, output, for display at presence-sensitive display 140 and in response to receiving the indication of the multi-touch gesture, a modified GUI that includes the first expandable element having a third size different from the first size. User interface device 138 also may be configured to, while the plurality of input points at presence-sensitive display 140 is located substantially within a fourth region of presence-sensitive display 140 that displays the second expandable element, output, for display at presence-sensitive display 140 and in response to receiving the indication of the multi-touch gesture, another modified GUI that includes the second expandable element having a fourth size different from the second size.

FIG. 3 is a block diagram that illustrates an example in which computing device 100 of FIG. 1 outputs graphical content for display at one or more remote display devices, in accordance with one or more aspects of this disclosure. Graphical content, generally, may include any visual information that may be output for display, such as text, images, a group of moving images, etc. The example shown in FIG. 3 includes computing device 100, presence-sensitive display 140, and communication device(s) 136 previously described with reference to FIG. 2. The example of FIG. 3 also includes a display device 10 and a presence-sensitive input device 12, which are included within presence-sensitive display 140, as well as a projector 24, a projector screen 122, a mobile computing device 126, and a display device 130. Although shown for purposes of example in FIGS. 1 and 2 as a stand-alone computing device, computing device 100 may, generally, be any component or system that includes one or more processors or other suitable computing environment for executing software instructions and, for example, need not include a presence-sensitive display (e.g., presence-sensitive display 140 of FIGS. 1 and 2).

As shown in the example of FIG. 3, computing device 100 may be one or more processors that include functionality as described with respect to processor(s) 130 of FIG. 2. In such examples, computing device 100 may be operatively coupled to presence-sensitive display 101 by a communication channel 103A, which may be a system bus or other suitable connection. Computing device 100 may also be operatively coupled to communication unit 110, further described below, by a communication channel 103B, which may also be a system bus or other suitable connection. Although shown separately as an example in FIG. 3, computing device 100 may be operatively coupled to presence-sensitive display 101 and communication unit 110 by any number of one or more communication channels.

In other examples, such as illustrated previously in FIGS. 1-2, computing device 100 may be a portable or mobile device such as mobile phones (including smart phones), laptop computers, etc. In some examples, computing device 100 may be a desktop computers, tablet computers, smart television platforms, cameras, personal digital assistants (PDAs), servers, mainframes, etc.

Presence-sensitive display 101, as shown in FIG. 1, may include display device 103 and presence-sensitive input device 105. Display device 103 may, for example, receive data from computing device 100 and display the graphical content. In some examples, presence-sensitive input device 105 may determine one or more user inputs (e.g., continuous gestures, multi-touch gestures, single-touch gestures, etc.) at presence-sensitive display 101 using capacitive, inductive, and/or optical recognition techniques and send indications of such user input to computing device 100 using communication channel 103A. In some examples, presence-sensitive input device 105 may be physically positioned on top of display device 103 such that, when a user positions an input unit over a graphical element displayed by display device 103, the location at which presence-sensitive input device 105 corresponds to the location of display device 103 at which the graphical element is displayed.

As shown in FIG. 3, computing device 100 may also include and/or be operatively coupled with communication unit 110. Communication unit 110 may include functionality of communication unit 44 as described in FIG. 2. Examples of communication unit 110 may include a network interface card, an Ethernet card, an optical transceiver, a radio frequency transceiver, or any other type of device that can send and receive information. Other examples of such communication units may include Bluetooth, 3G, and WiFi radios, Universal Serial Bus (USB) interfaces, etc. Computing device 100 may also include and/or be operatively coupled with one or more other devices, e.g., input devices, output devices, memory, storage devices, etc. that are not shown in FIG. 3 for purposes of brevity and illustration.

FIG. 3 also illustrates a projector 120 and projector screen 122. Other such examples of projection devices may include electronic whiteboards, holographic display devices, and any other suitable devices for displaying graphical content. Projector 120 and project screen 122 may include one or more communication units that enable the respective devices to communicate with computing device 100. In some examples, the one or more communication units may enable communication between projector 120 and projector screen 122. Projector 120 may receive data from computing device 100 that includes graphical content. Projector 120, in response to receiving the data, may project the graphical content onto projector screen 122. In some examples, projector 120 may determine one or more user inputs (e.g., continuous gestures, multi-touch gestures, single-touch gestures, etc.) at projector screen using optical recognition or other suitable techniques and send indications of such user input using one or more communication units to computing device 100.

Projector screen 122, in some examples, may include a presence-sensitive display 124. Presence-sensitive display 124 may include a subset of functionality or all of the functionality of UI device 4 as described in this disclosure. In some examples, presence-sensitive display 124 may include additional functionality. Projector screen 122 (e.g., an electronic whiteboard), may receive data from computing device 100 and display the graphical content. In some examples, presence-sensitive display 124 may determine one or more user inputs (e.g., continuous gestures, multi-touch gestures, single-touch gestures, etc.) at projector screen 122 using capacitive, inductive, and/or optical recognition techniques and send indications of such user input using one or more communication units to computing device 100.

FIG. 3 also illustrates tablet device 126 and visual display device 130. Tablet device 126 and visual display device 130 may each include computing and connectivity capabilities. Examples of tablet device 126 may include e-reader devices, convertible notebook devices, hybrid slate devices, etc. Examples of visual display device 130 may include televisions, computer monitors, etc. As shown in FIG. 3, tablet device 126 may include a presence-sensitive display 128. Visual display device 130 may include a presence-sensitive display 132. Presence-sensitive displays 128, 132 may include a subset of functionality or all of the functionality of UI device 4 as described in this disclosure. In some examples, presence-sensitive displays 128, 132 may include additional functionality. In any case, presence-sensitive display 132, for example, may receive data from computing device 100 and display the graphical content. In some examples, presence-sensitive display 132 may determine one or more user inputs (e.g., continuous gestures, multi-touch gestures, single-touch gestures, etc.) at projector screen using capacitive, inductive, and/or optical recognition techniques and send indications of such user input using one or more communication units to computing device 100.

As described above, in some examples, computing device 100 may output graphical content for display at presence-sensitive display 101 that is coupled to computing device 100 by a system bus or other suitable communication channel. Computing device 100 may also output graphical content for display at one or more remote devices, such as projector 120, projector screen 122, tablet device 126, and visual display device 130. For instance, computing device 100 may execute one or more instructions to generate and/or modify graphical content in accordance with techniques of the present disclosure. Computing device 100 may output the data that includes the graphical content to a communication unit of computing device 100, such as communication unit 110. Communication unit 110 may send the data to one or more of the remote devices, such as projector 120, projector screen 122, tablet device 126, and/or visual display device 130. In this way, computing device 100 may output the graphical content for display at one or more of the remote devices. In some examples, one or more of the remote devices may output the graphical content at a presence-sensitive display that is included in and/or operatively coupled to the respective remote devices.

In some examples, computing device 100 may not output graphical content at presence-sensitive display 101 that is operatively coupled to computing device 100. In other examples, computing device 100 may output graphical content for display at both a presence-sensitive display 101 that is coupled to computing device 100 by communication channel 103A, and at one or more remote devices. In such examples, the graphical content may be displayed substantially contemporaneously at each respective device. For instance, some delay may be introduced by the communication latency to send the data that includes the graphical content to the remote device. In some examples, graphical content generated by computing device 100 and output for display at presence-sensitive display 101 may be different than graphical content display output for display at one or more remote devices.

Computing device 100 may send and receive data using any suitable communication techniques. For example, computing device 100 may be operatively coupled to external network 18 using network link 16A. Each of the remote devices illustrated in FIG. 3 may be operatively coupled to external network 16A by one of respective network links 16B, 16C, and 16D. External network 18 may include network hubs, network switches, network routers, etc., that are operatively inter-coupled thereby providing for the exchange of information between computing device 100 and the remote devices illustrated in FIG. 3. In some examples, network links 16A-16D may be Ethernet, ATM or other network connections. Such connections may be wireless and/or wired connections.

In some examples, computing device 100 may be operatively coupled to one or more of the remote devices included in FIG. 3 using direct device communication 22. Direct device communication 22 may include communications through which computing device 100 sends and receives data directly with a remote device, using wired or wireless communication. That is, in some examples of direct device communication 22, data sent by computing device 100 may not be forwarded by one or more additional devices before being received at the remote device, and vice-versa. Examples of direct device communication 22 may include Bluetooth, Near-Field Communication, Universal Serial Bus, WiFi, infrared, etc. One or more of the remote devices illustrated in FIG. 3 may be operatively coupled with computing device 100 by communication links 20A-20D. In some examples, communication links 20A-20D may be connections using Bluetooth, Near-Field Communication, Universal Serial Bus, infrared, etc. Such connections may be wireless and/or wired connections.

In this manner, in accordance with the techniques of the disclosure, computing device 100 may output, for display at a display device (e.g., any of display device 10, projector 24, screen 26, mobile computing device 30, and display 34), a GUI that includes a substantially linear grouping of elements, the grouping including an expandable element having a first size. Computing device 100 may further, while the display device displays at least one of a first element and a last element of the grouping, receive an indication of a gesture detected at a presence-sensitive input device (e.g., any of presence-sensitive input devices 12, 28, 32, and 36), the gesture comprising a substantially linear movement of an input point substantially away from one of the at least one of the first and last elements. Computing device 100 may also, responsive to receiving the indication of the gesture, output, for display at the display device, a modified GUI that includes the expandable element having a second size different from the first size.

Alternatively, computing device 100 may output, for display at a display device (e.g., any of display device 10, projector 24, screen 26, mobile computing device 30, and display 34), a GUI that includes a first expandable element having a first size and a second expandable element having a second size. Computing device 100 may further receive an indication of a multi-touch gesture detected at a presence-sensitive input device (e.g., any of presence-sensitive input devices 12, 28, 32, and 36), the multi-touch gesture comprising a substantially linear movement of a plurality of input points detected as being present concurrently at the presence-sensitive input device from a first region of the presence-sensitive input device toward a second region of the presence-sensitive input device. Computing device 100 may still further, while the plurality of input points is located substantially within a third region of the presence-sensitive input device that corresponds to a region of the display device that displays the first expandable element, output, for display at the display device and in response to receiving the indication of the multi-touch gesture, a modified GUI that includes the first expandable element having a third size different from the first size. Computing device 100 may also, while the plurality of input points is located substantially within a fourth region of the presence-sensitive input device that corresponds to a region of the display device that displays the second expandable element, output, for display at the display device and in response to receiving the indication of the multi-touch gesture, another modified GUI that includes the second expandable element having a fourth size different from the second size.

FIGS. 4A-4C are conceptual diagrams that illustrate example GUIs provided by computing device 100 of FIG. 1, in accordance with one or more aspects of this disclosure. In particular, FIGS. 4A-4C illustrate examples in which computing device 100 outputs (e.g., via user interface device 138 in conjunction with user interface module 152 of FIGS. 1 and 2), for display at presence-sensitive display 140, GUI 102 that includes expandable elements 106-116 that are expanded or collapsed. In FIGS. 4A-4C, presence-sensitive display 140 is shown as being integrated within computing device 100. In other examples, presence-sensitive display 140 may be separate from computing device 100 (e.g., presence-sensitive display 140 may be a part of a remote terminal or display device communicatively coupled to computing device 100).

As shown in FIGS. 4A-4C, GUI 102 includes a substantially linear grouping (i.e., the vertical linear grouping shown in FIGS. 4A-4C) of elements 106-116. As also shown, each of elements 106-116 includes one of a variety of user notifications. As one example, as depicted in FIG. 4A, the substantially linear grouping of elements includes an expandable element having a first size (e.g., any of elements 106-116 having the particular size as shown in FIG. 4A). In the example of FIG. 4A, each of elements 106-116 is in a collapsed state, which corresponds to each of elements 106-116 having a particular (e.g., “first”) size. For example, when collapsed and having the particular size, each of elements 106-116 may exclusively include a first content portion. Additionally, when expanded and having a different (e.g., “second”) size, as described in greater detail below, each of elements 106-116 may include a second content portion in addition to the first content portion. In other words, as described in greater detail below, responsive to determining that a particular one of elements 106-116 has the first size, computing device 100 may output, for display at presence-sensitive display 140, GUI 102 such that the element exclusively includes the first content portion. Additionally, responsive to determining that the element has the second size larger than the first size, computing device 100 may output, for display at presence-sensitive display 140, GUI 102 such that the element includes the second content portion in addition to the first content portion.

In any case, computing device 100 may be configured to, while presence-sensitive display 140 displays at least one of first element 106 and last element 116 of the grouping, e.g., according to an ordering of elements 106-116 within the grouping, receive an indication of gesture 166 detected at presence-sensitive display 140 (e.g., via user interface device 138 in conjunction with gesture module 154 of FIGS. 1 and 2). In this example, gesture 166 may include a substantially linear movement of an input point substantially away from the one of the at least one of first and last elements 106, 116 in a direction that is substantially parallel to a direction in which the expandable element expands (e.g., a direction indicated by a corresponding one of arrows 118-128).

As a result of, or responsive to, computing device 100 receiving the indication of gesture 166 in the above-described manner, one or more of elements 106-116 may be expanded using gesture 166, as depicted in FIGS. 4B and 4C, and as described below. As shown in FIGS. 4A-4C, gesture 166 proceeds in a direction from boundary 162 toward boundary 164 of region 104 of presence-sensitive display 140 used to display the substantially linear grouping of elements 106-116. In the example of FIGS. 4A-4C, first element 106 is aligned with boundary 162 of region 104, and last element 116 is located elsewhere within region 104. In other examples, one or both of first and last elements 106, 116 may be aligned with the corresponding ones of boundaries 162, 164 of region 104. Additionally, although gesture 166 is depicted in FIGS. 4A-4C as being performed using a finger, in other examples, gesture 166 may be performed using any object, including a stylus, or another object. Additionally, in still other examples, gesture 166 may be performed using multiple fingers or objects, including multiple styli, or other objects.

In the example of FIG. 4B, element 106 is expanded using gesture 166. In particular, computing device 100 may be configured to, responsive to receiving the indication of gesture 166, output, for display at presence-sensitive display 140, a modified GUI 102, as depicted in FIG. 4B, that includes element 106 having a second size (i.e., the particular size of element 106 as shown in FIG. 4B) different from the first size. In this example, because element 106 is expanded, the second size of element 106, as depicted in FIG. 4B, is larger than the first size, as shown in FIG. 4A. In FIG. 4B, element 106 is expanded in a direction of expansion indicated by arrow 118 of element 106. For example, as shown, element 106 is expanded such that elements 108-116 are shifted downward within region 104 used to display the grouping of elements 106-116 toward boundary 164.

In FIG. 4C, the steps described above with reference to element 106 are repeated to expand element 108 using the same gesture, i.e., gesture 166. Specifically, element 108 is expanded in a direction of expansion indicated by arrow 120 of element 108. In this manner, elements 106 and 108 are expanded using gesture 166, which may be a continuous gesture, in a successive manner. For example, as shown in FIG. 4C, element 108 is expanded such that elements 110-116 are once again shifted downward within region 104 toward boundary 164.

Additionally, as explained above, any of elements 106-116 may be collapsed using a gesture that is similar to gesture 166 described above, in a similar, albeit reciprocal manner. As one example, one or more of elements 106-116 may be in an expanded state, which may correspond to the respective elements each having a particular (e.g., “first”) size. For example, when expanded and having the particular size, each of the elements may include a first content portion in addition to a second content portion. When collapsed and having a different (e.g., “second”) size, however, each of the elements may exclusively include the first content portion. In this “collapsing” example, once again, while presence-sensitive display 140 displays at least one of first and last elements 106, 116 of the grouping, e.g., according to an ordering of elements 106-116 within the grouping, computing device 100 may be configured to receive an indication of a gesture, similar to gesture 166, detected at presence-sensitive display 140. For example, the gesture may once again include a substantially linear movement of an input point substantially away from one of the at least one of first and last elements 106, 116 in a direction that is substantially parallel to a direction in which a particular one of the expanded expandable element expands. In this example, however, the substantially linear movement may be in a direction that is reversed relative to the direction of the substantially linear movement of the previous “expansion” example. Specifically, in this example, the gesture may be in a direction from boundary 164 toward boundary 162 of region 104. Also in this example, computing device 100 may be further configured to, responsive to receiving the indication of the gesture, output, for display at presence-sensitive display 140, a modified GUI 102 that includes the previously expanded expandable element originally having the particular size now having the different size. In other words, the modified GUI 102 may include the expandable element collapsed.

FIGS. 5A-5C are conceptual diagrams that illustrate additional example GUIs provided by computing device 100 of FIG. 1, in accordance with one or more aspects of this disclosure. In particular, in a similar manner as described above with reference to FIGS. 4A-4C, FIGS. 5A-5C illustrate examples in which computing device 100 outputs for display at presence-sensitive display 140 GUI 102 that includes expandable elements 106-116 that are expanded or collapsed. In FIGS. 5A-5C, presence-sensitive display 140 is once again shown as being integrated within computing device 100. In other examples, presence-sensitive display 140 may be separate from computing device 100 (e.g., presence-sensitive display 140 may be a part of a remote terminal or display device communicatively coupled to computing device 100).

As shown in FIGS. 5A-5C, GUI 102 includes elements 106-116. In particular, as shown in FIG. 5A, GUI 102 includes a first expandable element having a first size and a second expandable element having a second size (e.g., any two elements among elements 106-116, each having the particular size as shown in FIG. 5A). As also shown, each of elements 106-116 includes one of a variety of user notifications. In the example of FIG. 5A, each of elements 106-116 is once again in a collapsed state, which corresponds to each of elements 106-116 having a particular size. For example, when collapsed and having the particular size, each of elements 106-116 may exclusively include a first content portion. Additionally, when expanded and having a different, e.g., larger size, each of elements 106-116 may include a second content portion in addition to the first content portion.

Computing device 100 may be configured to receive an indication of multi-touch gesture 168A-168B detected at presence-sensitive display 140. In this example, multi-touch gesture 168A-168B may include a substantially linear movement of a plurality of input points detected concurrently at presence-sensitive display 140 from a first region of presence-sensitive display 140 toward a second region of presence-sensitive display 140. For example, the first and second regions may correspond to any portions of region 104 of presence-sensitive display 140 used to display elements 106-116, including portions located within, or outside of, regions of presence-sensitive display 140 used to display any of elements 106-116. As depicted in FIGS. 5A-5C, multi-touch gesture 168A-168B proceeds in a direction from boundary 162 toward boundary 164 previously described. In other examples, multi-touch gesture 168A-168B may proceed in a different direction, e.g., from boundary 164 toward boundary 162. Additionally, although multi-touch gesture 168A-168B is depicted as being performed using two fingers, in other examples, multi-touch gesture 168A-168B may be performed using any two or more objects, including two or more styli, or other objects. In any case, one or more of elements 106-116 may be expanded using multi-touch gesture 168A-168B, as depicted in FIGS. 5B and 5C, and as described below.

In FIG. 5B, element 106 is expanded using multi-touch gesture 168A-168B. In particular, computing device 100 may be configured to, while the plurality of input points at presence-sensitive display 140 is located substantially within a region of presence-sensitive display 140 that displays element 106, output, for display at presence-sensitive display 140 and in response to receiving the indication of multi-touch gesture 168A-168B, a modified GUI 102, as depicted n FIG. 5B, that includes element 106 having a third size (i.e., the particular size of element 106 as shown in FIG. 5B) different from the first size. As shown in FIG. 5B, element 106 is expanded in a direction of expansion indicated by arrow 118 of element 106. For example, as shown, element 106 is expanded such that elements 108-116 are shifted downward within region 104 toward second boundary 164.

In FIG. 5C, the steps described above with reference to element 106 are repeated to expand element 108 using multi-touch gesture 168A-168B. Specifically, computing device 100 may be configured to, while the plurality of input points at presence-sensitive display 140 is located substantially within a region of presence-sensitive display 140 that displays element 108, output, for display at presence-sensitive display 140 and in response to receiving the indication of multi-touch gesture 168A-168B, another modified GUI 102, as depicted in FIG. 5C, that includes element 108 having a fourth size (i.e., the particular size of element 106 as shown in FIG. 5C) different from the first size. In this example, element 108 is once again expanded in a direction of expansion indicated by arrow 120 of element 108. In this manner, elements 106 and 108 are expanded using multi-touch gesture 168A-168B, which may be a continuous gesture, in a successive manner. For example, as shown in FIG. 5C, element 108 is expanded, such that elements 110-116 are once again shifted downward within region 104 toward second boundary 164.

Additionally, as explained above, any of elements 106-116 may be collapsed using a gesture that is similar to multi-touch gesture 168A-168B described above, in a similar, but reciprocal manner. As one example, one or more of elements 106-116 may be in an expanded state, which may correspond to the respective elements each having a particular size. For example, when expanded and having the particular size, each of the elements may include a first content portion in addition to a second content portion. When collapsed and having a different size, however, each of the elements may exclusively include the first content portion. In this “collapsing” example, once again, computing device 100 may be configured to receive an indication of a multi-touch gesture, similar to multi-touch gesture 168A-168B, detected at presence-sensitive display 140. For example, the multi-touch gesture may once again include a substantially linear movement of a plurality of input points detected concurrently at presence-sensitive display 140 from a first region of presence-sensitive display 140 toward a second region of presence-sensitive display 140. In this example, however, the substantially linear movement may be in a direction that is reversed relative to the direction of the substantially linear movement of the previous “expansion” example. Specifically, in this example, the multi-touch gesture may be in a direction from boundary 164 toward boundary 162 of region 104. Also in this example, computing device 100 may be further configured to, responsive to receiving the indication of the multi-touch gesture, output, for display at presence-sensitive display 140, a modified GUI 102 that includes one or more of the previously expanded expandable elements, each originally having the particular size, now having the different size. In other words, the modified GUI 102 may include each of the one or more expandable elements collapsed.

Additionally, the steps described above with reference to FIGS. 4A-4C and 4A-4C and elements 106 and 108 may be repeated to expand or collapse additional elements of elements 106-116, such as, e.g., element 110, using the same or similar gesture, i.e., any of gesture 166 and multi-touch gesture 168A-168B. In this manner, elements 106 and 108, as well as any additional elements of elements 106-116, may be expanded or collapsed using any of gesture 166 and multi-touch gesture 168A-168B in a successive manner. For example, each of gesture 166 and multi-touch gesture 168A-168B may be a continuous gesture.

Furthermore, in the example of FIGS. 4A-4C and 5A-5C described above, each of gesture 166 and multi-touch gesture 168A-168B may include a contact with presence-sensitive display 140, or a presence within close proximity to presence-sensitive display 140 (i.e., sufficient proximity to be detected by presence-sensitive display 140). Additionally, gesture 166 and multi-touch gesture 168A-168B, and any contact or proximity points associated therewith, may correspond to a region, rather than a single point, on presence-sensitive display 140. Furthermore, in this example, gesture 166 and multi-touch gesture 168A-168B, including any of the contact or proximity points, may correspond to one or more distinct placements of a finger, a stylus, or another object, onto, or within proximity to, presence-sensitive display 140.

In addition to the examples of FIGS. 4A-4C and 5A-5C described above, in other examples, computing device 100 may be configured to expand or collapse elements 106-116 in other directions. For example, computing device 100 may be configured to expand or collapse elements 106-116 in directions that include any combination of upward/downward, left/right, and diagonal directions. Furthermore, although elements 106-116 are depicted as having rectangular geometries, one or more of elements 106-116 may have different geometries, such as square, circular, oval, as well as any number of other geometries. Additionally, while elements 106-116 are depicted as being located in particular regions and locations within GUI 102, specifically, within the corresponding portions of region 104 of presence-sensitive display 140 used to display elements 106-116, each of elements 106-116, both in their collapsed as well as expanded states, may be located elsewhere within GUI 102.

FIG. 6 is a flowchart that illustrates an example process for visually expanding or collapsing one or more graphical elements using a single gesture, in accordance with one or more aspect of this disclosure. For purposes of illustration only, FIG. 6 will be described with respect to computing device 100 shown in FIG. 2, and the example GUIs, and various components thereof, shown in FIGS. 4A-4C. In other examples, the techniques illustrated in FIG. 6 may be implemented by another mobile computing device, e.g., a mobile computing device having additional or fewer components and/or other functionality.

In this example, computing device 100 may output, for display at presence-sensitive display 140, GUI 102 (e.g., GUI 102 as depicted in FIG. 4A). For example, GUI 102 may include a substantially linear grouping of elements 106-116. In this example, the grouping may include expandable element 106 having a first size (e.g., the size of expandable element 106 as depicted in FIG. 4A) (602). As described above, in some examples, first expandable element 106 may include content that notifies a user of an event.

Also in this example, computing device 100 may, while presence-sensitive display 140 displays at least one of first element 106 and last element 116 of the grouping, e.g., according to an ordering of elements 106-116 within the grouping, receive an indication of gesture 166 detected at presence-sensitive display 140. For example, gesture 166 may include a substantially linear movement of an input point substantially away from one of the at least one of first and last elements 106, 116 in a direction that is substantially parallel to a direction in which expandable element 106 expands (e.g., a direction indicated by arrow 118 of expandable element 106) (604). As shown in the example of FIGS. 4A-4C, expandable element 106 and first element 106 are the same expandable element within the grouping. In other examples, expandable element 106 may be a different expandable element than first element 106. For example, expandable element 106 may be any of the remaining expandable elements 108-116 of the grouping.

In some examples, presence-sensitive display 140 may display the grouping of elements 106-116 in its entirety, e.g., in instances where all of elements 106-116 of the grouping are capable of being displayed on presence-sensitive display 140 at the same time. In these examples, presence-sensitive display 140 may display the at least one of first and last elements 106, 116 such that one or both of first and last elements 106, 116 are aligned with a corresponding one of boundaries 162, 164 of region 104 of presence-sensitive display 140 used to display GUI 102, and, in particular, the grouping of elements 106-116. In other words, in these examples, the grouping may be displayed such that one or both of first and last elements 106, 116 are displayed in their entirety and located adjacent to the corresponding ones of boundaries 162, 164 of region 104. In some examples, one of first and last elements 106, 116 may be displayed in its entirety and located adjacent to the corresponding one of boundaries 162, 164. In these examples, the other one of first and last elements 106, 116 may be displayed elsewhere on presence-sensitive display 140, e.g., somewhere within region 104, rather than proximate to any of boundaries 162, 164, as depicted in FIGS. 4A-4C. In other examples, however, both first and last elements 106, 116 may be displayed in their entirety and located adjacent to the corresponding ones of boundaries 162, 164.

In other examples, presence-sensitive display 140 may be unable to display the grouping of elements 106-116 in its entirety, e.g., in instances where elements 106-116 exceed the size of region 104. In these examples, only a subset of elements 106-116 may be displayed within region 104 at any given time. In such cases, the remaining elements of the grouping may not be displayed, or remain “hidden,” e.g., until computing device 100 receives an indication of a user gesture (e.g., a “scroll” gesture), and outputs a modified GUI 102. In the modified GUI 102, one or more of the remaining elements may be displayed within region 104, while one or more of the presently displayed elements may no longer be displayed. Accordingly, in these examples, presence-sensitive display 140 may display the at least one of first and last elements 106, 116 such that only one of first and last elements 106, 116 is displayed in its entirety and located adjacent to the corresponding one of boundaries 162, 164 of region 104. In these examples, the other one of first and last elements 106, 116 (as well as any number of other elements of the grouping) may not be displayed within region 104.

In any case, in this example, computing device 100 may, responsive to receiving the indication of gesture 166, output, for display at presence-sensitive display 140, a modified GUI 102 (i.e., GUI 102 as depicted in FIG. 4B) that includes expandable element 106 having a second size (e.g., the size of expandable element 106 as depicted in FIG. 4B) different from the first size (606). As one example, computing device 100 may output the “modified” version of GUI 102 in place of the “original” version of GUI 102, such that expandable element 106 has the second size, by expanding or collapsing expandable element 106 having the first size, as described above with reference to FIGS. 4A-4B.

In some examples, presence-sensitive display 140 may display the at least one of first element 106 and last element 116 such that at least one of first and last elements 106, 116 is aligned with one of boundaries 162, 164 of region 104. For example, as shown in FIGS. 4A-4C, presence-sensitive display 140 displays first element 106 such that first element 106 is located adjacent to boundary 162, and second element 116 such that second element 116 is located elsewhere within region 104, i.e., not adjacent to boundary 164. In the example of FIGS. 4A-4C, boundaries 162, 164 at least in part define region 104 of presence-sensitive display 140 used to display the grouping of elements 106-116.

Additionally, in other examples, presence-sensitive display 140 may display each of the at least one of first element 106 and last element 116 in its entirety. For example, as shown in FIGS. 4A-4C, presence-sensitive display 140 displays each of first and last elements 106, 116 (and, in particular, first element 106 located adjacent to boundary 162), such that substantially all of the respective element, rather than, e.g., a portion of the element, is displayed on presence-sensitive display 140.

Furthermore, in still other examples, each of the at least one of first element 106 and last element 116 may be an outer element of the substantially linear grouping of elements 106-116 including expandable element 106. In these examples, the outer element may be an element located at one of a beginning and an ending of the grouping.

In some examples, the substantially linear grouping of elements 106-116 described above may be one of a substantially vertical grouping, a substantially horizontal grouping, and a substantially diagonal grouping. In other examples, the substantially linear grouping may be any other type of grouping, including any combination of the substantially vertical, horizontal, and diagonal groupings.

In other examples, a direction of the substantially linear movement may be one of a substantially vertical direction, a substantially horizontal direction, and a substantially diagonal direction.

In still other examples, the direction in which expandable element 106 expands may be one of a substantially vertical direction, a substantially horizontal direction, and a substantially diagonal direction. In other examples, the direction in which expandable element 106 expands may be any other direction, including any combination of the substantially vertical, horizontal, and diagonal directions.

In some examples, if expandable element 106 described above has the first size, expandable element 106 may exclusively include a first content portion. Furthermore, if expandable element 106 has the second size, expandable element 106 may include a second content portion in addition to the first content portion. Alternatively, in other examples, if expandable element 106 has the first size, expandable element 106 may include the second content portion in addition to the first content portion, while, if expandable element 106 has the second size, expandable element 106 may exclusively include the first content portion.

In other words, in these examples, responsive to determining that expandable element 106 has the first size, computing device 100 may output, for display at presence-sensitive display 140, expandable element 106 such that expandable element 106 exclusively includes the first content portion. Additionally, responsive to determining that expandable element 106 has the second size larger than the first size, computing device 100 may output, for display at presence-sensitive display 140, expandable element 106 such that expandable element 106 includes the second content portion in addition to the first content portion.

In still other examples, each of the first and second sizes of expandable element 106 also described above may be one of a minimum size and a maximum size of expandable element 106. In this manner, the techniques described herein may be applicable to both expanding and collapsing an expandable element, including expanding or collapsing the expandable element in a sequential manner (i.e., expanding followed by collapsing, or collapsing followed by expanding).

In some examples, the substantially linear movement of the input point substantially away from the at least one of first and last elements 106, 116 in the direction that is substantially parallel to the direction in which expandable element 106 expands may include a substantially linear movement of a continuous input region on presence-sensitive display 140. For example, the continuous input region may include one or more pixels of presence-sensitive display 140 at any given time. As one example, the continuous input region may correspond to a single point of contact, or a single region of contact, of a finger or a stylus with presence-sensitive display 140. As another example, the continuous input region may correspond to a single object (e.g., a finger, or a stylus) located within sufficient proximity to presence-sensitive display 140 so as to be detected by presence-sensitive display 140. In some examples, gesture 166 may be initiated within one of a first region of presence-sensitive display 140 that displays expandable element 106, a second region of presence-sensitive display 140 that is outside of (e.g., proximate to) the first region, and a boundary shared by the first and second regions. In general, however, gesture 166 need not necessarily be initiated within, or outside of (e.g., proximate to), the first region, or within a boundary shared by the first region and another region of presence-sensitive display 140, in the manner described above. In other examples, gesture 166 may be initiated anywhere within region 104 of presence-sensitive display 140 used to display GUI 102, and, in particular, the grouping of elements 106-116.

As previously described, gesture 166 may be, or be a part of, a “scroll” (or “scrolling”) gesture in response to which computing device 100 outputs, for display at presence-sensitive display 140, GUI 102, such that presence-sensitive display 140 displays the at least one of first and last elements 106, 116 in the manner described above. In other words, gesture 166 may be, or be a part of, the scroll gesture that causes computing device 100 to output, for display at presence-sensitive display 140, the grouping of elements 106-116, such presence-sensitive display 140 displays one or both of a beginning and an ending of the grouping.

In other examples, expandable element 106 described above may be a first expandable element, i.e., first expandable element 106. In these examples, the grouping of elements 106-116 may further include a second expandable element, i.e., second expandable element 108, having a third size (e.g., the size of expandable element 108 as depicted in FIGS. 4A and 4B). In a similar manner as described above, in some examples, second expandable element 108 also may include content that notifies a user of an event. Also in these examples, after outputting the modified GUI 102 that includes first expandable element 106 having the second size, computing device 100 may further, responsive to receiving the indication of gesture 166, output, for display at presence-sensitive display 140, another modified GUI 102 that includes second expandable element 108 having a fourth size different from the third size. In a similar manner as described above with reference to step (506), computing device 100 may output the “further modified” version of GUI 102 in place of the “modified” version of GUI 102, such that second expandable element 108 has the fourth size, by expanding or collapsing second expandable element 108 having the third size, as described above with reference to FIGS. 4B-4C.

In still other examples, each of the first and second sizes of first expandable element 106 also described above may be one of a minimum size and a maximum size of first expandable element 106. As such, after fully expanding or fully collapsing first expandable element 106 in the manner described above, such that first expandable element 106 has a maximum size or a minimum size of first expandable element 106, computing device 100 may expand or collapse (e.g., fully or partially) second expandable element 108. More generally, however, any of the first, second, third, and fourth sizes of first and second expandable elements 106, 108 described above may correspond to a minimum or a maximum size of the respective expandable element. In this manner, the techniques described herein may be applicable to both expanding and collapsing one or more expandable elements, including expanding or collapsing one expandable element followed by expanding or collapsing another expandable element, as well as expanding and collapsing a particular expandable element in a sequential manner (i.e., expanding followed by collapsing, or collapsing followed by expanding).

In the above-described examples, the input point may be a first input point. In these examples, gesture 166 may further include a substantially linear movement of a second input point substantially away from the one of the at least one of first and last elements 106, 116 in the direction that is substantially parallel to the direction in which first expandable element 106 expands. In other words, in these examples, gesture 166 may be a multi-touch gesture, by virtue of gesture 166 including the substantially linear movements of the first and second input points (e.g., corresponding to first and second fingers and/or styli) in the manner described above. In other examples, gesture 166 may include substantially linear movements of addition input points (e.g., corresponding to additional fingers and/or styli), in a similar manner as described above.

In some examples, first expandable element 106 may be located relatively closer to the one of the at least one of first and last elements 106, 116 (indeed, in the example of FIGS. 4A-4C, first expandable element 106 is the same as first element 106) within the grouping of elements 106-116, than second expandable element 108. Alternatively, in other examples, second expandable element 108 may be located relatively closer to the one of the at least one of first and last elements 106, 116, than first expandable element 106. In any case, in these examples, computing device 100 may expand or collapse first expandable element 106, followed by expanding or collapsing second expandable element 108. In this manner, elements 106-116 of the grouping may be expanded or collapsed in a “top-to-bottom,” or a “bottom-to-top” manner. Stated another way, elements of the grouping of elements 106-116 located relatively closer to the one of the at least one of first and last elements 106, 116 (which may include any of first and last elements 106, 116 themselves) may be expanded or collapsed prior to expanding or collapsing elements of the grouping located relatively farther from the one of the at least one of first and last elements 106, 116, and vice versa.

In some examples, gesture 166 may be initiated within a region of presence-sensitive display 140 that displays expandable element 106. For example, gesture 166 may be initiated inside the region, or on a boundary of the region and another region of presence-sensitive display 140. In these examples, gesture 166 may further include a substantially linear movement of the input point substantially toward the one of the at least one of first element 106 and last element 116 and substantially parallel to the direction in which expandable element 106 expands. For example, in gesture 166, this additional substantially linear movement of the input point may be performed after performing the above-described substantially linear movement of the input point substantially away from the one of the at least one of first and last elements 106, 116. In other words, in some examples, gesture 166 may include two separate substantially linear movements of the input point in opposite directions. As one example, gesture 166 may be a collapsing gesture, and may include an initial downward movement of the input point to initiate gesture 166, followed by a subsequent upward movement of the input point to perform gesture 166 to collapse a previously expanded version of expandable element 106.

In other examples, to output the modified GUI 102 that includes expandable element 106 having the second size different from the first size, computing device 100 may output the modified GUI 102 when (e.g., in response to detecting that) the input point is located outside of the region of presence-sensitive display 140 that displays expandable element 106. In other words, in some examples, gesture 166 may be initiated within the region of presence-sensitive display 140 that displays expandable element 106, as described above. However, in these examples, computing device 100 may respond to the gesture (i.e., output for display at presence-sensitive display 140 the modified GUI 102 that includes expandable element 106 having the second size) after the input point has moved outside of the region of presence-sensitive display 104 that displays expandable element 106.

Computing device 100 may implement process 600 to enable a user to more easily expand or collapse one or more expandable elements of GUI 102 output by computing device 100 for display at presence-sensitive display 140, compared to other techniques. As illustrated by the example described above, computing device 100 performing process 600 may enable the user to expand or collapse multiple expandable elements of GUI 102 using a single gesture, e.g., a single continuous gesture. Additionally, as also illustrated by the above-described example, computing device 100 performing process 600 also may enable the user to successively expand or collapse the multiple expandable elements of GUI 102 using the single gesture, e.g., to the extent desired by the user. Furthermore, as also illustrated by the above-described example, computing device 100 performing process 600 may enable the user to expand or collapse a particular expandable element of GUI 102 using the single gesture in instances where using another expansion or collapsing gesture that requires placement of one or more fingers or styli within a region of presence-sensitive display 140 that displays the expandable element (e.g., a two-finger “swipe” or “tug” gesture, a two-finger “pinch-out” gesture, or an equivalent gesture) may be difficult or impractical.

In this manner, computing device 100 represents an example of a computing device configured to perform operations including the steps of outputting, by the computing device and for display at a display device, a GUI that includes a substantially linear grouping of elements, the grouping including an expandable element having a first size, while the display device displays at least one of a first element and a last element of the grouping, receiving, by the computing device, an indication of a gesture detected at a presence-sensitive input device, the gesture including a substantially linear movement of an input point substantially away from one of the at least one of the first and last elements, and, responsive to receiving the indication of the gesture, outputting, by the computing device and for display at the display device, a modified GUI that includes the expandable element having a second size different from the first size.

FIG. 7 is a flowchart that illustrates another example process for visually expanding or collapsing one or more graphical elements using a single gesture, in accordance with one or more aspects of this disclosure. For purposes of illustration only, FIG. 7 will be described with respect to computing device 100 shown in FIG. 2, and the example GUIs, and various components thereof, shown in FIGS. 5A-5C. In other examples, the techniques illustrated in FIG. 7 may be implemented by another mobile computing device, e.g., a mobile computing device having additional or fewer components and/or other functionality.

In this example, computing device 100 may output, for display at presence-sensitive display 140, GUI 102 (e.g., GUI 102 as depicted in FIG. 5A). For example, GUI 102 may include first expandable element 106 having a first size and second expandable element 108 having a second size (e.g., the respective sizes of first and second expandable elements 106, 108, as depicted in FIG. 5A) (702). In a similar manner as described above, in some examples, each of first and second expandable elements 106, 108 may include content that notifies a user of an event.

Also in this example, computing device 100 may receive an indication of multi-touch gesture 168A-168B detected at presence-sensitive display 140. For example, multi-touch gesture 168A-168B may include a substantially linear movement of a plurality of input points detected concurrently at presence-sensitive display 140 from a first region of presence-sensitive display 140 toward a second region of presence-sensitive display 140 (704). As one example, as shown in FIGS. 5A-5C, multi-touch gesture 168A-168B may correspond to a two-finger gesture sometimes referred to as a “swipe” or “tug” gesture. In other examples, however, multi-touch gesture 168A-168B may correspond to any multi-finger gesture, or to any multi-point or multi-region gesture, generally.

Also in this example, computing device 100 may, while the plurality of input points at presence-sensitive display 140 is located substantially within a third region of presence-sensitive display 140 that displays first expandable element 106, output, for display at presence-sensitive display 140 and in response to receiving the indication of multi-touch gesture 168A-168B, a modified GUI 102 (e.g., GUI 102 as depicted in FIG. 5B) that includes first expandable element 106 having a third size (e.g., the size of first expandable element 106 as depicted in FIG. 5B) different from the first size (706). As one example, computing device 100 may output the “modified” version of GUI 102 in place of the “original” version of GUI 102, such that first expandable element 106 has the third size, by expanding or collapsing first expandable element 106 having the first size, as described above with reference to FIGS. 5A-5B.

Also in this example, computing device 100 may, while the plurality of input points at presence-sensitive display 140 is located substantially within a fourth region of presence-sensitive display 140 that displays second expandable element 108, output, for display at presence-sensitive display 140 and in response to receiving the indication of multi-touch gesture 168A-168B, another modified GUI 102 (e.g., GUI 102 as depicted in FIG. 5C) that includes second expandable element 108 having a fourth size (e.g., the size of second expandable element 108 as depicted in FIG. 5C) different from the second size (708). As one example, computing device 100 may output the “further modified” version of GUI 102 in place of the “modified” version of GUI 102, such that second expandable element 108 has the fourth size, by expanding or collapsing second expandable element 108 having the second size, in a similar manner as described above with reference to step (706).

In these examples, the plurality of input points being located substantially within each of the third and fourth regions may correspond to the plurality of input points being located substantially on a boundary of the respective region. For example, the boundary of the respective region may be shared with another region of presence-sensitive display 140. Furthermore, also in these examples, computing device 100 may output the further modified version of GUI 102 that includes second expandable element 108 having the fourth size after outputting the modified version of GUI 102 that includes first expandable element 106 having the third size. In other words, after expanding or collapsing first expandable element 106 in response to receiving the indication of multi-touch gesture 168A-168B, computing device 100 may expand or collapse second expandable element 108, also in response to receiving the indication of multi-touch gesture 168A-168B.

In some examples, GUI 102 described above may include a substantially linear grouping of elements including first expandable element 106 and second expandable element 108. For example, the substantially linear grouping may be one of a substantially vertical grouping, a substantially horizontal grouping, and a substantially diagonal grouping. In other examples, the substantially linear grouping may be any other type of grouping, including any combination of the substantially vertical, horizontal, and diagonal groupings.

In some examples, if each of first and second expandable elements 106, 108 described above has the corresponding one of the first and second sizes, the respective expandable element may exclusively include a first content portion. Furthermore, if the respective expandable element has the corresponding one of the third and fourth sizes, the respective expandable element may include a second content portion in addition to the first content portion. Alternatively, in other examples, if each of first and second expandable elements 106, 108 has the corresponding one of the first and second sizes, the respective expandable element may include the second content portion in addition to the first content portion. Additionally, if the respective expandable element has the corresponding one of the third and fourth sizes, the respective expandable element may exclusively include the first content portion.

In still other examples, each of the first and third sizes of first expandable element 106 also described above may be one of a minimum size and a maximum size of first expandable element 106. As such, after fully expanding or fully collapsing first expandable element 106 in the manner described above, such that first expandable element 106 has a maximum size or a minimum size of first expandable element 106, computing device 100 may expand or collapse (e.g., fully or partially) second expandable element 108. More generally, however, any of the first, second, third, and fourth sizes of first and second expandable elements 106, 108 described above may correspond to a minimum or a maximum size of the respective expandable element. In this manner, the techniques described herein may be applicable to both expanding and collapsing one or more expandable elements, including expanding or collapsing one expandable element followed by expanding or collapsing another expandable element, as well as expanding and collapsing a particular expandable element in a sequential manner (i.e., expanding followed by collapsing, or collapsing followed by expanding).

In some examples, the substantially linear movement of the plurality of input points detected concurrently at presence-sensitive display 140 from the first region of presence-sensitive display 140 toward the second region of presence-sensitive display 140, as described above, may include a substantially linear movement of a plurality of continuous input regions detected concurrently at presence-sensitive display 140. For example, each of the plurality of continuous input regions may include one or more pixels of presence-sensitive display 140 at any given time. As one example, each of the plurality of continuous input regions may correspond to a single point of contact, or a single region of contact, of a finger or a stylus with presence-sensitive display 140. As another example, each of the plurality of continuous input regions may correspond to a single object (e.g., a finger, or a stylus) located within sufficient proximity to presence-sensitive display 140 so as to be detected by presence-sensitive display 140.

In other examples, the substantially linear movement of the plurality of input points detected concurrently at presence-sensitive display 140 from the first region of presence-sensitive display 140 toward the second region of presence-sensitive display 140, as described above, may be in a direction that is substantially parallel to a direction, as indicated by arrows 118 and 120, in which each of first and second expandable elements 106, 108 expands. For example, in instances where first and second expandable elements 106, 108 expand in one of horizontal, vertical, and diagonal directions, the substantially linear movement of the plurality of input points may be substantially in a same direction.

In some examples, multi-touch gesture 168A-168B described above may be initiated within one of the third region of presence-sensitive display 140 that displays first expandable element 106, a fifth region of presence-sensitive display 140 that is outside of (e.g., proximate to) the third region, and a boundary shared by the third and fifth regions. In general, however, multi-touch gesture 168A-168B need not necessarily be initiated within, or outside of (e.g., proximate to), the third region, or within a boundary shared by the third region and another region of presence-sensitive display 140, in the manner described above. In some examples, multi-touch gesture 168A-168B may be initiated anywhere within region 104 of presence-sensitive display 140 used to display GUI 102, and, in particular, first and second expandable elements 106, 108. Nevertheless, as explained above, computing device 100 may only expand or collapse each of the first and second expandable elements 106, 108 while the plurality of input points at presence-sensitive display 140 is located substantially within the corresponding one of the third and fourth regions of presence-sensitive display 140 that displays the respective expandable element.

In other examples, the substantially linear movement of the plurality of input points detected concurrently at presence-sensitive display 140 from the first region of presence-sensitive display 140 toward the second region of presence-sensitive display 140, as described above, may be a continuous movement. For example, the substantially linear movement may be initiated at the first region and proceed toward the second region in a continuous manner (i.e., without any interruption in the movement of the plurality of input points). As one example, the substantially linear movement may include one or more pauses in the movement of the plurality of input points, without discontinuities in the movement itself (e.g., as a result of a user removing one or more fingers and/or styli from the proximity of presence-sensitive display 140). Additionally, the movement may terminate at another region of presence-sensitive display 140, which may include the second region, or a different region. Computing device 100 may implement process 700 to enable a user to more easily expand or collapse one or more expandable elements of GUI 102 output by computing device 100 for display at presence-sensitive display 140, compared to other techniques. As illustrated by the example described above, computing device 100 performing process 700 may enable the user to expand or collapse multiple expandable elements of GUI 102 using a single gesture, e.g., a single continuous gesture. Additionally, as also illustrated by the above-described example, computing device 100 performing process 700 also may enable the user to successively expand or collapse the multiple expandable elements of GUI 102 using the single gesture, e.g., to the extent desired by the user. Furthermore, as also illustrated by the above-described example, computing device 100 performing process 700 may enable the user to expand or collapse a particular expandable element of GUI 102 using the single gesture in instances where using another expansion or collapsing gesture that requires placement of one or more fingers or styli within a region of presence-sensitive display 140 that displays the expandable element (e.g., a two-finger “swipe” or “tug” gesture, a two-finger “pinch-out” gesture, or an equivalent gesture) may be difficult or impractical.

In this manner, computing device 100 represents an example of a computing device configured to perform operations including the steps of outputting, by the computing device and for display at a display device, a GUI that includes a first expandable element having a first size and a second expandable element having a second size, receiving, by the computing device, an indication of a multi-touch gesture detected at a presence-sensitive input device, the multi-touch gesture including a substantially linear movement of a plurality of input points detected as being present concurrently at the presence-sensitive input device from a first region of the presence-sensitive input device toward a second region of the presence-sensitive input device, while the plurality of input points is located substantially within a third region of the presence-sensitive input device that corresponds to a region of the display device that displays the first expandable element, outputting, by the computing device for display at the display device and in response to receiving the indication of the multi-touch gesture, a modified GUI that includes the first expandable element having a third size different from the first size, and while the plurality of input points is located substantially within a fourth region of the presence-sensitive input device that corresponds to a region of the display device that displays the second expandable element, outputting, by the computing device for display at the display device and in response to receiving the indication of the multi-touch gesture, another modified GUI that includes the second expandable element having a fourth size different from the second size.

Techniques described herein may be implemented, at least in part, in hardware, software, firmware, or any combination thereof. For example, various aspects of the described embodiments may be implemented within one or more processors, including one or more microprocessors, DSPs, ASICs, FPGAs, or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware also may perform one or more of the disclosed techniques.

Such hardware, software, and firmware may be implemented within the same device or within separate devices to support the various techniques described herein. In addition, any of the described units, modules or components may be implemented together or separately as discrete but interoperable logic devices. Depiction of different features as modules or units is intended to highlight different functional aspects and does not necessarily imply that such modules or units are realized by separate hardware, firmware, or software components. Rather, functionality associated with one or more modules or units may be performed by separate hardware, firmware, or software components, or integrated within common or separate hardware, firmware, or software components.

Techniques described herein also may be embodied or encoded in an article of manufacture including a computer-readable storage medium encoded with instructions. Instructions embedded or encoded in an article of manufacture including an encoded computer-readable storage medium, may cause one or more programmable processors, or other processors, to implement one or more of the techniques described herein, such as when instructions included or encoded in the computer-readable storage medium are executed by the one or more processors. Computer readable storage media may include RAM, read only memory (ROM), programmable read only memory (PROM), EPROM, EEPROM, flash memory, a hard disk, a compact disc ROM (CD-ROM), a floppy disk, a cassette, magnetic media, optical media, or other computer readable media. Additional examples of computer readable medium include computer-readable storage devices, computer-readable memory, and tangible computer-readable medium. In some examples, an article of manufacture may include one or more computer-readable storage media.

In some examples, computer-readable storage media may include non-transitory media. The term “non-transitory” may indicate that the storage medium is tangible and is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
outputting, by a computing device and for display at a display device, a graphical user interface that includes a linear grouping of graphical notifications, the linear grouping of graphical notifications including an expandable graphical notification having a first size, the expandable graphical notification including a first content portion and a second content portion;
while the display device displays the expandable graphical notification and at least a first graphical notification of the linear grouping of graphical notifications, receiving, by the computing device, an indication of a continuous gesture detected at a presence-sensitive input device, the continuous gesture being initiated at a location of the presence-sensitive input device corresponding to a location of the display device at which the expandable graphical notification is displayed, the continuous gesture comprising a first linear movement of an input point away from the first graphical notification followed by a second linear movement of the input point towards the first graphical notification; and
responsive to receiving the indication of the continuous gesture, outputting, by the computing device and for display at the display device, a modified graphical user interface that includes the expandable graphical notification having a second size smaller than the first size and exclusively including the first content portion.

2. The method of claim 1, wherein the display device displays the at least one of the first graphical notification and a last graphical notification of the linear grouping of graphical notifications such that at least one of the first and last graphical notifications is aligned with a boundary of a region of the display device used to display the linear grouping of graphical notifications.

3. The method of claim 1, wherein each of the first graphical notification and a last graphical notification of the linear grouping of graphical notifications comprises an outer graphical notification of the linear grouping of graphical notifications including the expandable graphical notification, wherein the outer graphical notification comprises a graphical notification located at one of a beginning and an ending of the grouping.

4. The method of claim 1, wherein the linear grouping of graphical notifications comprises one of a vertical grouping, a horizontal grouping, and a diagonal grouping.

5. The method of claim 1, wherein a direction of the linear movement comprises one of a vertical direction, a horizontal direction, and a diagonal direction.

6. The method of claim 1, further comprising:
receiving, by the computing device, an indication of a gesture detected at the presence-sensitive input device, the gesture comprising a linear movement away from the first graphical notification, wherein the expandable graphical notification has the second size and exclusively includes the first content portion; and
responsive to receiving the indication of the gesture, outputting, by the computing device and for display at the display device, the expandable graphical notification at the first size and including the second content portion in addition to the first content portion.

7. The method of claim 1, wherein the continuous gesture is terminated within one of a first region of the presence-sensitive input device that corresponds to a region of the display device that displays the expandable graphical notification, a second region of the presence-sensitive input device that corresponds to a region of the display device that is outside of the first region, and a boundary shared by the first and second regions.

8. The method of claim 1, wherein the expandable graphical notification comprises a first expandable graphical notification, and wherein the linear grouping of graphical notifications further comprises a second expandable graphical notification having a third size, the method further comprising:
after outputting the modified graphical user interface that includes the first expandable graphical notification having the second size, responsive to receiving the indication of the continuous gesture, outputting, by the computing device and for display at the display device, another modified graphical user interface that includes the second expandable graphical notification having a fourth size different from the third size.

9. The method of claim 8, wherein the input point comprises a first input point, and wherein the continuous gesture further comprises a linear movement of a second input point away from the one of the at least one of the first graphical notification and a last graphical notification of the linear grouping of graphical notifications.

10. The method of claim 8, wherein the first expandable graphical notification is located relatively closer to the one of the at least one of the first graphical notification and a last graphical notification of the linear grouping of graphical notifications within the linear grouping of graphical notifications than the second expandable graphical notification.

11. (canceled)

12. The method of claim 1, wherein outputting the modified graphical user interface that includes the expandable graphical notification having the second size different from the first size comprises outputting the modified graphical user interface in response to determining that the input point is located outside of the region of the presence-sensitive input device that corresponds to the region of the display device that displays the expandable graphical notification.

13-18. (canceled)

19. A computing device comprising one or more processors configured to:
output, for display at a display device, a graphical user interface that includes a linear grouping of graphical notifications, the linear grouping of graphical notifications including an expandable graphical notification having a first size, the expandable graphical notification including a first content portion and a second content portion;
while the display device displays the expandable graphical notification and at least a first graphical notification of the linear grouping of graphical notifications, receive an indication of a continuous gesture detected at a presence-sensitive input device, the continuous gesture being initiated at a location of the presence-sensitive input device corresponding to a location of the display device at which the expandable graphical notification is displayed, the continuous gesture comprising a linear movement of an input point away from the first graphical notification followed by a second linear movement of the input point towards the first graphical notification; and
responsive to receiving the indication of the continuous gesture, output, for display at the display device, a modified graphical user interface that includes the expandable graphical notification having a second size smaller than the first size and exclusively including the first content portion.

20. (canceled)

21. The computing device of claim 19, wherein the one or more processors are configured to output, for display at the display device, the at least one of the first graphical notification and a last graphical notification of the linear grouping of graphical notifications such that at least one of the first and last graphical notifications is aligned with a boundary of a region of the display device used to display the linear grouping of graphical notifications.

22. The computing device of claim 19, wherein each of the first graphical notification and a last graphical notification of the linear grouping of graphical notifications comprises an outer graphical notification of the linear grouping of graphical notifications including the expandable graphical notification, wherein the outer graphical notification comprises a graphical notification located at one of a beginning and an end of the grouping of graphical notifications.

23. The computing device of claim 19, wherein the one or more processors are further configured to:
receive an indication of a gesture detected at the presence-sensitive input device, the gesture comprising a linear movement away from the first graphical notification, wherein the expandable graphical notification has the second size and exclusively includes the first content portion; and
responsive to receiving the indication of the gesture, output, for display at the display device, the expandable graphical notification at the first size and including the second content portion in addition to the first content portion.

24. The computing device of claim 19, wherein the continuous gesture is terminated within one of a first region of the presence-sensitive input device that corresponds to a region of the display device that displays the expandable graphical notification, a second region of the presence-sensitive input device that corresponds to a region of the display device that is outside of the first region, and a boundary shared by the first and second regions.

25. The computing device of claim 19, wherein the expandable graphical notification comprises a first expandable graphical notification, wherein the linear grouping of graphical notifications further comprises a second expandable graphical notification having a third size, and wherein the one or more processors are further configured to:
after outputting the modified graphical user interface that includes the first expandable graphical notification having the second size, and responsive to receiving the indication of the continuous gesture, output, for display at the display device, another modified graphical user interface that includes the second expandable graphical notification having a fourth size different from the third size.

26. (canceled)

27. A non-transitory computer-readable storage medium encoded with instructions for causing one or more processors of a computing device to:
output, for display at a display device, a graphical user interface that includes a linear grouping of graphical notifications, the linear grouping of graphical notifications including an expandable graphical notification having a first size, the expandable graphical notification including a first content portion and a second content portion;
while the display device displays the expandable graphical notification and at least a first graphical notification of the linear grouping of graphical notifications, receive an indication of a continuous gesture detected at a presence-sensitive input device, the continuous gesture being initiated at a location of the presence-sensitive input device corresponding to a location of the display device at which the expandable graphical notification is displayed, the continuous gesture comprising a linear movement of an input point away from the first graphical notification followed by a second linear movement of the input point towards the first graphical notification; and
responsive to receiving the indication of the continuous gesture, output, for display at the display device, a modified graphical user interface that includes the expandable graphical notification having a second size smaller than the first size and exclusively including the first content portion.

28. The non-transitory computer-readable storage medium of claim 27, wherein instructions further cause the one or more processors to:
receive an indication of a gesture detected at the presence-sensitive input device, the gesture comprising a linear movement away from the first graphical notification, wherein the expandable graphical notification has the second size and exclusively includes the first content portion; and
responsive to receiving the indication of the gesture, output, for display at the display device, the expandable graphical notification at the first size and including the second content portion in addition to the first content portion.

29. The non-transitory computer-readable storage medium of claim 27, wherein the expandable element comprises a first expandable element, wherein the linear grouping of elements further comprises a second expandable element having a third size, and wherein the instructions further cause the one or more processors to:
after outputting the modified graphical user interface that includes the first expandable element having the second size, and responsive to receiving the indication of the continuous gesture, output, for display at the display device, another modified graphical user interface that includes the second expandable element having a fourth size different from the third size.
